(19) United States
(12) Patent Application Publication
(10) Pub. No.: US 2010/0044454 A1
(43) Pub. Date: Feb. 25, 2010

(54) WATER SPRAY NOZZLE AND METHOD OF OPTIMIZATION OF WORKING PARAMETERS OF WATER SPRAY NOZZLE

(76) Inventor: Krzysztof Karazniewicz, Stargard Szczecinski (PL)

Correspondence Address: Horst M. Kasper, 13 Forest Drive, Warren, NJ, 07059, US

(21) Appl. No.: 12/448,516

(22) PCT Filed: Dec. 19, 2007
(86) PCT No.: PCT/PL2007/000081

§ 371 Date: Jun. 23, 2009

(30) Foreign Application Priority Data
Jan. 2, 2007 (PL) P 381456

(51) Int. Cl. B05B 1/34; E03C 1/08

(52) U.S. Cl. 239/8; 239/463; 239/428.5

(57) ABSTRACT

The nozzle contains at least one swirl chamber (8), which is cylindrical in shape and situated between the spin chamber (7) and the outlet opening (4), and the diameter (d1) of the first swirl chamber (8), connected with a spin chamber (7), is less than the diameter (D) of the spin chamber (7). When the number of swirl chambers (8) is greater than one, the diameter (d2) of each following swirl chamber (9) is less than that of the preceding swirl chamber (8). The nozzle has an outlet chamber (10), which sides have one or more air inlet. The method of optimization of the working parameters of the water spray nozzle consists in that the stream drawn from the water supply conduit is supplied into the spin chamber (7) entirely or at least 95% through the spin channels (6, 6′) and the stream is put through one or more successive cylindrical swirl chamber(s) (8, 9) having decreasing diameters (d2<d1), and then it is directed to the outlet opening (4). Next the stream is put through an injector device in the form of an outlet chamber (10) in the nozzle body (1, 13), or in another external unit, which chamber (10) has in its walls one or more air inlet channels.

The subject matter of the invention is a water spray nozzle and the method of optimization of the working parameters of the water spray nozzle designed especially to use in mining organs of mechanical coal miners and to control dust conditions as well as to cool undercut groove.

It is known that there are water nozzles in case of which the supplied water is passed through a spin insert and a spin chamber situated above it. The spin chamber set the liquid stream in spinning and causes that the liquid leaves the opening of the nozzle as a swirl liquid cone which bends in a sprayed liquid jet consisting of very small drops. Such nozzles have a body with a hollow inner hole in which the spin insert is mounted. The insert has a central water inlet opening, and on its outer circumference it has oblique or spiral spin grooves which set the water supplied into the cylindrical nozzle opening in rotational motion. The part of the cylindrical hole, which is situated in the space above the insert, is a spin chamber in which the outlets of the spin grooves are arranged and where the liquid is set in spinning.

It is known from the Polish utility model description PL 44406 a spray nozzle consisting of a body and a spin insert situated in the inlet opening of the nozzle from the side of water conduit. The spin insert has an axial hole through which the water is supplied into the space above it, constituting a spin chamber, and it also has on its circumference a spiral spin groove which leads a part of the jet drawn from the water conduit. Opposite the face of the spin insert, it is situated a nozzle piece with an outlet hole which is coaxial with the longitudinal hole of the nozzle. The outer face of this piece is in the shape of a truncated cone, and between this face and the face of the nozzle body it is situated a cylindrical outlet chamber. The water drawn from the water supply conduit flows through the axial hole of the spin insert as well as through its spiral groove. Then it flows out through the outlet opening in the outlet chamber, where water drops become homogeneous, and from there it is led to a dust source.

It is known from the Polish utility model description PL 54283 a spray nozzle the body of which contains a hollow cylindrical blind hole constituting a spin chamber, terminated in an outlet opening the diameter of which is at least equal to the diameter of the cylindrical part of this chamber. In the nozzle body there are two channels which supply the liquid into the nozzle, are arranged normal to the axial surface of the nozzle, oppositely each other and tangent to the spin chamber, causing rotational motion of the water in the chamber.

Scientific research shows that the sprinkling of dustiness in hard coal mines with water under high pressure, at an outflow pressure of about 10 MPa at the nozzle, is an effective method because the water is broken up into a spray of very small drops, and a greater number of drops increases the chance that water drops will come into contact with dust grains. The nozzles used in coal-mining have outflow openings usually from 0.6 mm to 3.6 mm and work at a pressure of 0.6-6.0 MPa. In each case an increase of the diameter of an outflow opening or an increase in pressure is connected with an increase of the discharge of water. In the conditions of high dustiness caused by coal dust nozzles with small diameters as well as nozzles working at a lower water pressure have a tendency to become blocked, which has an adverse influence on their operation and it is necessary to replace them often. The danger of coal dust or methane explosion, and also the risk of dust disease to working miners will increase in these conditions. Nozzles with outlet openings of larger diameters or those working at high water pressure are characterized by a relatively large expenditure of water, which rises considerably the costs of operation of dust removal equipment, has an adverse influence on the coal quality and sometimes cause that it becomes necessary to drain an excessive water amount.

The nozzle according to the invention, which includes a body in the shape of a solid of revolution with a cylindrical inner hole, provided with spin elements, is characterized by that the cylindrical hole in the body contains at least one swirl chamber, which is cylindrical in shape and situated between the spin chamber and the outlet opening, and the diameter of the first swirl chamber, connected with a spin chamber, is less than the diameter of the spin chamber. When the number of swirl chambers is greater than one, the diameter of each following swirl chamber is less than that of the preceding swirl chamber. Advantageously, the nozzle has two swirl chambers, the first swirl chamber connected with the spin chamber, and the second swirl chamber connected with the first swirl chamber. Advantageously, the spin chamber is connected with the water supply conduit in such a way that the whole water stream supplied into the nozzle flows through spin channels. Advantageously, the spin chamber is connected with the supply system through the spin channels of the spin insert seated in the cylindrical hole of the body from the side of water conduit. Advantageously, the spin chamber is connected with the supply system through the spin channels situated directly in the nozzle body, tangent to the spin chamber and oppositely each other, and the cylindrical hole in the body is closed from the bottom. Advantageously, the spin chamber is connected with the water supply conduit in such a way that at least 95% of the stream supplied into the nozzle flow in the spin channels, while the rest part of the stream flows through a longitudinal supply channel the axis of which is parallel to the longitudinal axis of the spin chamber. Advantageously, the spin channels and the longitudinal supply channel are arranged in the spin insert seated in the cylindrical hole of the body from the water conduit. Advantageously, the nozzle has a spin insert in the shape of a roll having advantageously two spin channels in the form of cylindrical holes in the insert body. The channels are positioned at an acute angle relative to the longitudinal axis of the insert, oppositely each other on both sides of the axis, and the outlets of these channels are near by the insert edge. Advantageously, the nozzle has a spin insert in the shape of a roll having spin channels in the form of grooves, which are advantageously rectangular, situated on its circumference along a screw line. Advantageously, the spin insert is terminated in a flange the diameter of which is greater than the diameter of the inlet opening in the body. Advantageously, the spin insert is shaped like a mushroom the stem of which is seated in the spin chamber, while the head in the inlet part of the cylindrical hole in the body. Advantageously, the body has an outlet chamber located over the outlet opening. Advantageously, the outlet chamber has one or more air inlet channels the inlet openings of which are arranged on its outer side, while the outlet openings are inside the chamber. Advantageously, the air inlet channels are in cross-section circular in shape. Advantageously, the air inlet channels have the shape of a circular truncated cone or conical ellipsoid the greater base of which is situated in the outlet chamber. Advantageously, the air inlet channels are made so that the surface areas of their outlet openings are greater than the surface areas of their inlet openings. Advantageously, the ratio of the surface area of the outlet opening to the surface area of the inlet opening exceeds 1.16. The ratios of the surface areas for the individual inlet channels may be identical or different. Advantageously, the axes of the air inlet channels are situated at a certain distance from the axial plane of the outlet chamber, advantageously at an equal distance. Advantageously, the inlet channels have the side surfaces one side internally tangent to the wall of the outlet chamber. Advantageously, the axes of the air inlet channels converge at one point. The axes of the air inlet channels can intersect the axial plane of the chamber on the same level or on different levels. Advantageously, the nozzle body is shaped like a roll whose lower end part has an external thread, and the upper end part in the shaped like a head has outside the shape corresponding to the function of angular rotation, advantageously that of a hexagon, and the outlet chamber is inside the head. Advantageously, the nozzle body has the shape of a roll which has a circumferential groove shaped like an asymmetric trapezoid on its outer surface near its base, and above it another circumferential groove is situated.

The nature of the solution according to the variant of the invention relating to the nozzle lies in that the water spray nozzle containing the body with the cylindrical hole made along its axis, containing the components which form the stream in the shape of a cone, and the outlet chamber situated over the outlet opening of the nozzle is characterized by that the outlet chamber has one or more air inlet channels the inlet openings of which are arranged on its outer side, while the outlet openings are inside the chamber. Advantageously, the air inlet channels are circular in cross-section. Advantageously, the air inlet channels have the shape of a circular truncated cone or conical ellipsoid the greater base of which is positioned in the outlet chamber. Advantageously, the air inlet channels are made so that the surface areas of their outlet openings are grater than the surface areas of their inlet openings. Advantageously, the ratio of the surface area of the outlet opening to that of the inlet opening is equal to or greater than 1.16. Advantageously, the ratios of the surface areas of the outlet openings to the surface areas of the inlet openings for the individual air inlet channels may be identical or different. Advantageously, the axes of the air inlet channels are situated at a certain distance from the axial plane of the outlet chamber. Advantageously, the inlet channels have the side surface one side internally tangent to the wall of the outlet chamber. Advantageously, the axes of the air inlet channels converge at one point. The axes of the air inlet channels may intersect the axial plane of the chamber on the same level or on different levels. Advantageously, the nozzle has a spin insert shaped like a roll with spin channels, which is seated in the cylindrical hole of the body from the water conduit, and the axes of these channels are positioned at an acute angle relative to its longitudinal axis so that the channel outlets are in the spin chamber, which is coaxial with the cylindrical hole of the nozzle, near by the wall of this chamber. Advantageously, the spin channels have the form of holes in the spin insert body, the outlets of which are situated near the outer insert edge. Advantageously, the spin channels are positioned on the circumference of the spin insert along a screw line and are shaped like grooves, advantageously rectangular ones. Advantageously, the nozzle has at least two spin channels situated directly in the nozzle body, transversely to the longitudinal axis of the cylindrical hole and tangent to the spin chamber as well as oppositely each other, and the outlets of these channels are inside the spin chamber, and the cylindrical hole in the body is closed from the bottom. Advantageously, between the spin chamber and the outlet opening there is one or there are more cylindrical spin chamber(s), out of which the diameter of each following spin chamber is less than the diameter of the preceding one, and the first swirl chamber has the diameter less than the diameter of the spin chamber, respectively. Advantageously, the nozzle has two swirl chambers, the first swirl chamber connected with the spin chamber and the second swirl chamber connected with the first swirl chamber and with the outlet opening. Advantageously, the spin chamber is connected with the water supply conduit so that the whole stream supplied into the nozzle flows through the spin channels. Advantageously, the spin chamber is connected with the water supply conduit so that at least 95% of the stream supplied into the nozzle flow through the spin channels, while the rest part of the stream flows in the longitudinal supply channel in the insert body, and the axis of this channel is parallel to the longitudinal axis of the insert. Advantageously, the body has the shape of a roll whose lower end part has an external thread, while the upper end part shaped like a head has outside the shape corresponding to the function of angular rotation, advantageously of a hexagon, and inside the head there is the outlet chamber with an outlet opening in its bottom. Advantageously, the body is shaped like a roll, which has a circumferential groove in the shape of an asymmetric trapezoid on its outer surface near to the base, and another circumferential groove is located above it.

The nature of the invention concerning the method consists in that the whole stream drawn from the water supply conduit is supplied into the spin chamber entirely or at least 95% through the spin channels positioned at an angle relative to its longitudinal axis. Next the stream is put through one or more successive cylindrical swirl chamber(s) having different diameters, and then it is directed to the outlet opening. The diameter of each following swirl chamber is less than that of the preceding chamber, and the diameter of the first swirl chamber is less than that of the spin chamber. Advantageously, the stream flowing from the outlet opening is put through an injector device in the form of an outlet chamber in the nozzle body, or in another external unit, which chamber has in its walls one or more hole(s) constituting air inlet channels. Advantageously, one uses air inlet channels the outer inlet openings of which have the surface areas less than the surface areas of the inlet openings situated inside the chamber. Advantageously, the ratio of the surface area of the outlet opening to that of the inlet opening is equal to or greater than 1.16.

The solution according to the invention gives new possibilities to shape the working parameters of sprinkling or spray nozzles paying special attention to the optimization of the parameters of water-air yet as well as the optimization of water consumption and also operation parameters. The nozzle according to the invention ensures that the stream is being atomized to a high degree, and water drops have a suitable kinetic energy necessary to catch effectively dust particles contained in the air, and also increases considerably the range of yet. The extension of yet range and the increase in yet effectiveness in removing coal dust from the atmosphere as well as more effective cooling of undercut groove reduces considerably methane and coal dust explosion hazard. The solution makes it possible to enlarge the diameter of the outlet opening, reduce water consumption and lengthen the life of the nozzle, maintaining optimal yet parameters and high effectiveness in dustiness control.

The subject matter of the invention is explained more accurately in the examples of realization and in the drawings, where

FIG. 1 represents in axial section the nozzle, which has two swirl chambers with a spin insert represented partly in half-view and party in half-section,

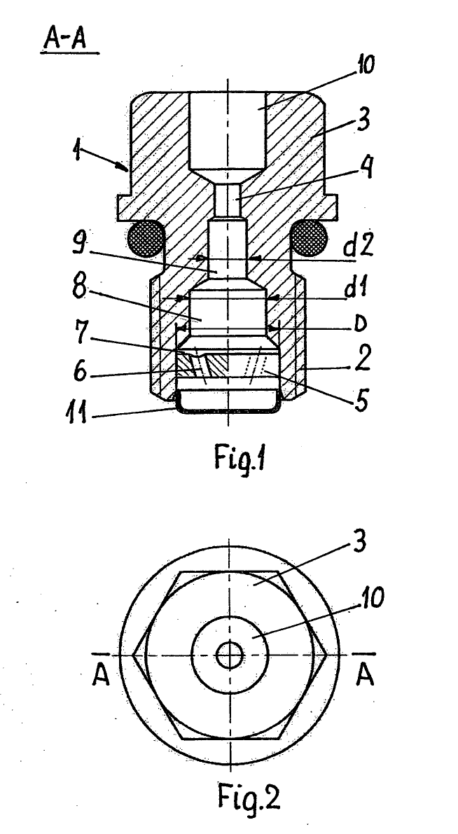

FIG. 2 represents the nozzle from FIG. 1 in top view,

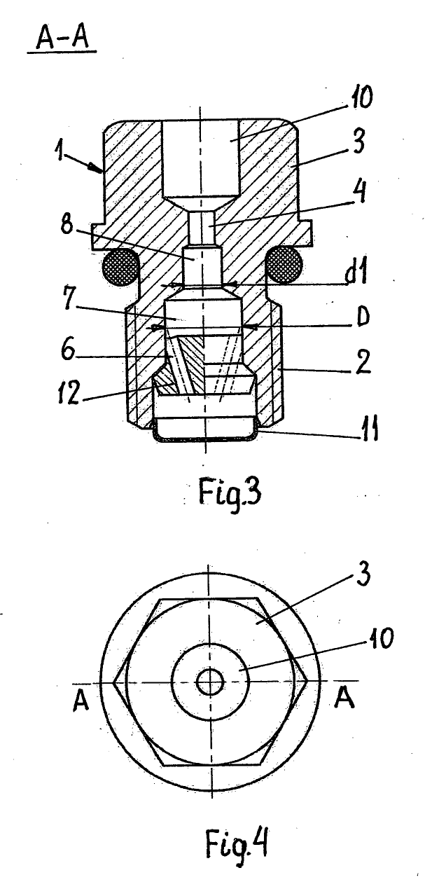

FIG. 3 represents a constructional variant of the nozzle in axial section, containing one swirl chamber with a constructional variant of the spin insert represented partly in half-view and partly in half-section,

FIG. 4 represents the nozzle from FIG. 3 in top view,

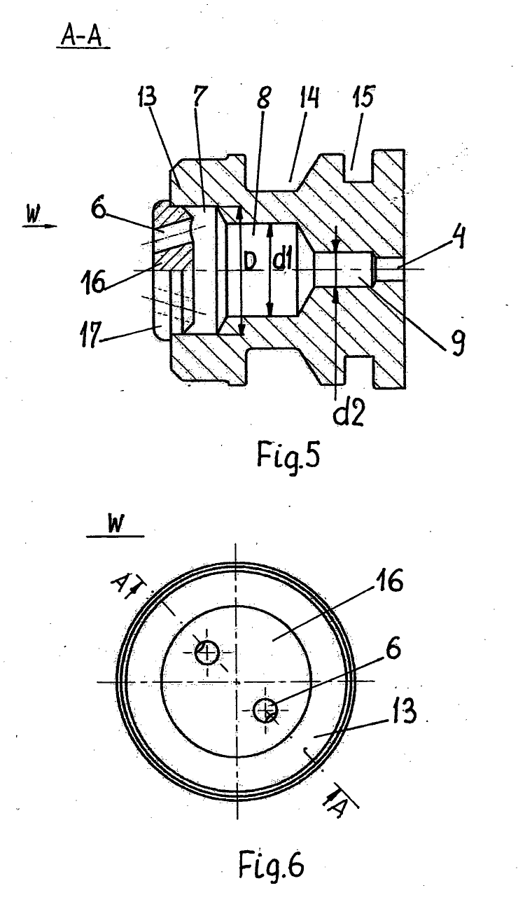

FIG. 5 represents in axial section another variant of the nozzle, the body of which has a different outer shape, with another spin insert,

FIG. 6 represents the nozzle from FIG. 5 in bottom view,

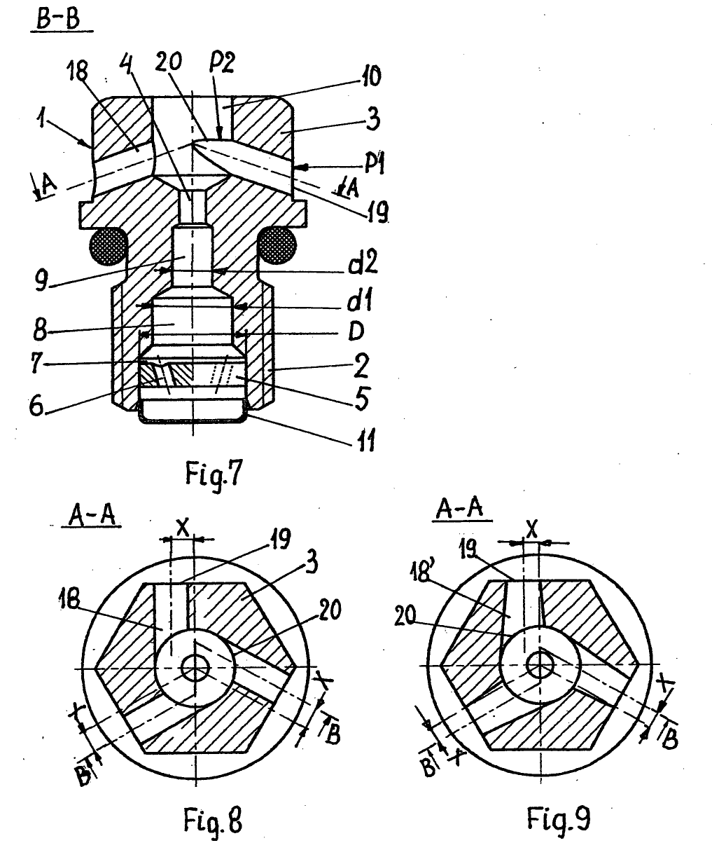

FIG. 7 represents a constructional variant of the nozzle, with air inlet channels, in longitudinal section in the plane B-B as marked in FIG. 8 and in FIG. 9,

FIG. 8 represents a nozzle with circular air inlet channels, in section in the plane A-A as marked in FIG. 7,

FIG. 9 represents in section in the plane A-A another form of the nozzle from FIG. 7 with conical air inlet channels,

FIG. 10 represents a nozzle with a constructional variant of nozzle insert, in longitudinal section in the plane B-B as marked in FIG. 11 and in FIG. 12,

FIG. 11 represents the nozzle with circular air inlet channels in section in the plane A-A as marked in FIG. 10,

FIG. 12 represents in section in the plane A-A another form of the nozzle from FIG. 10 with conical air inlet channels,

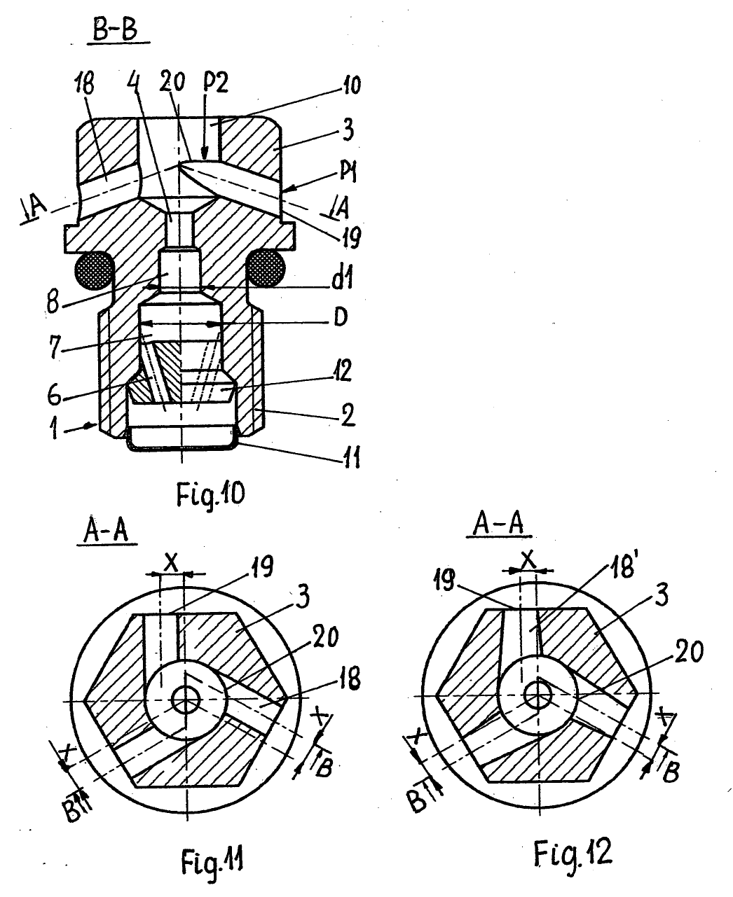

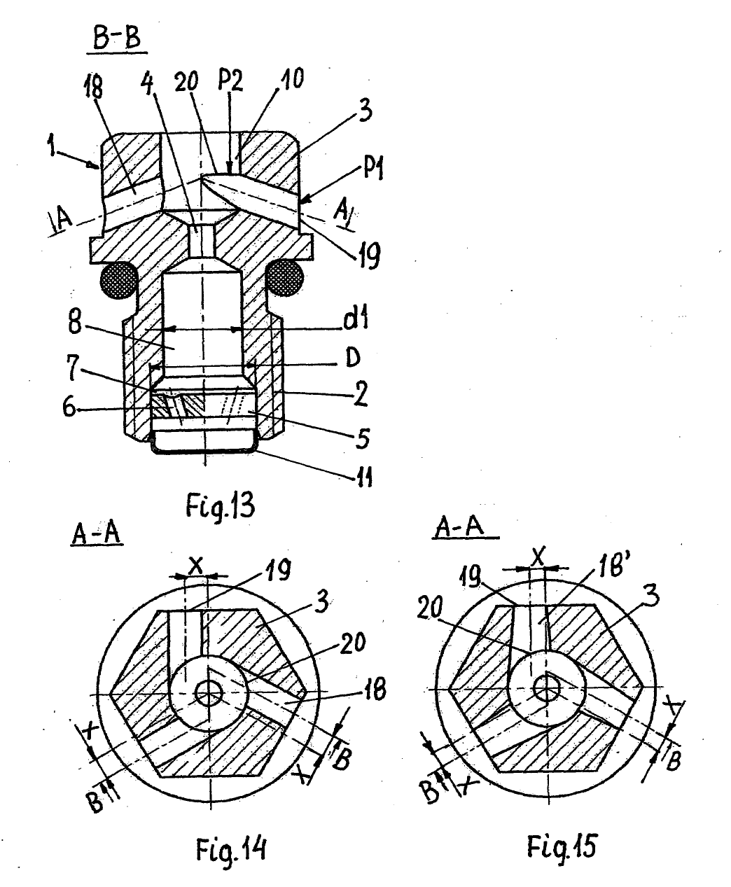

FIG. 13 represents a constructional variant of the nozzle in longitudinal section in the plane B-B as marked in FIG. 14 and in FIG. 15,

FIG. 14 represents the nozzle with circular air inlet channels in section in the plane A-A as marked in FIG. 13,

FIG. 15 represents in section in the plane A-A another form of the nozzle from FIG. 13 with conical air inlet channels,

FIG. 16 represents another constructional variant of the nozzle with one air inlet channel in longitudinal section in the plane B-B as marked in FIG. 17 and in FIG. 18,

FIG. 17 represents the nozzle with one circular air inlet channel in section in the plane A-A as marked in FIG. 16,

FIG. 18 represents in section in the plane A-A another form of the nozzle from FIG. 16 with one conical air inlet channel,

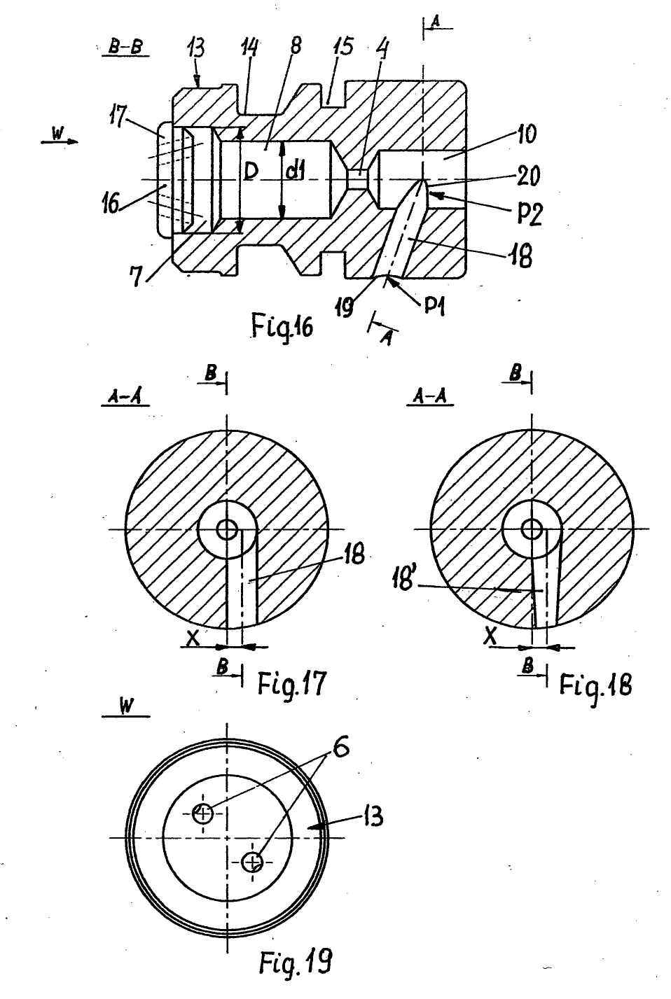

FIG. 19 represents the nozzle from FIG. 16 in bottom view,

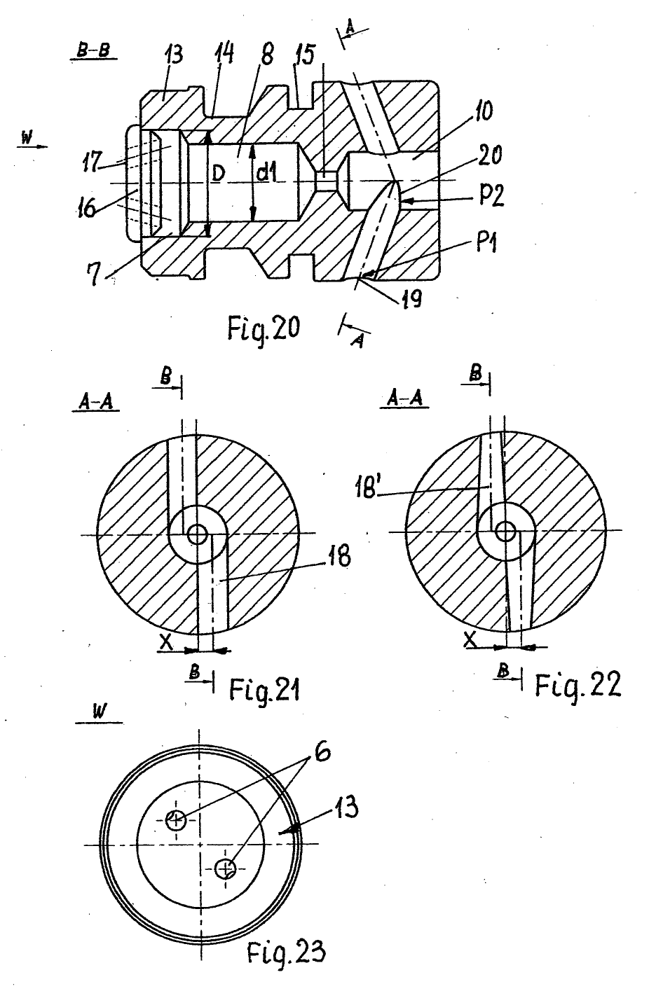

FIG. 20 represents a constructional variant of the nozzle with two air inlet channels, in longitudinal section in the plane B-B as marked in FIG. 21 and in FIG. 22,

FIG. 21 represents the nozzle with circular air inlet channels, in section in the plane A-A as marked in FIG. 20,

FIG. 22 represents in section in the plane A-A another form of the nozzle from FIG. 20, with conical air inlet channels,

FIG. 23 represents the nozzle from FIG. 20 in bottom view,

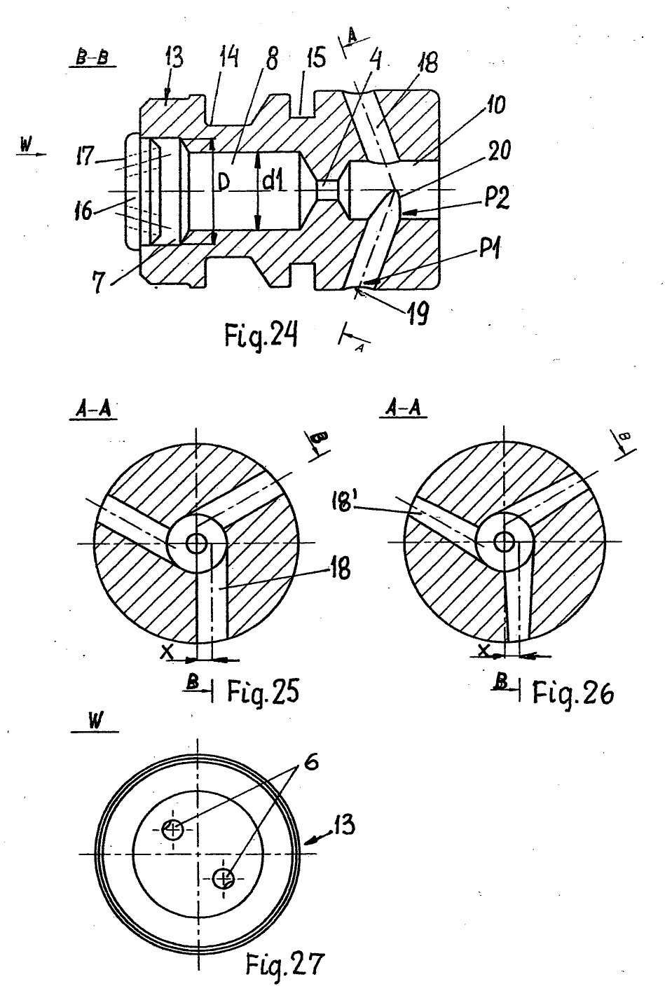

FIG. 24 represents a constructional variant of the nozzle with three air inlet channels, in longitudinal section in the plane B-B as marked in FIG. 25 and in FIG. 26,

FIG. 25 represents the nozzle with circular air inlet channels, in section in the plane A-A as marked in FIG. 24,

FIG. 26 represents in section in the plane A-A another form of the nozzle from FIG. 24, with conical air inlet channels,

FIG. 27 represents the nozzle from FIG. 24 in bottom view,

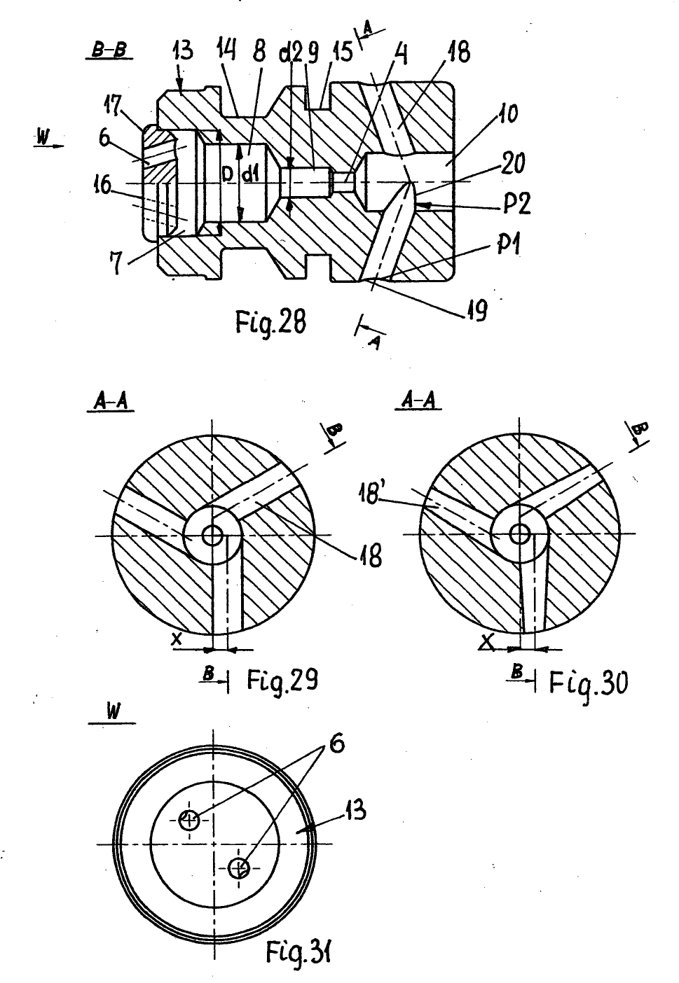

FIG. 28 represents a constructional variant of the nozzle in longitudinal section in the plane B-B as marked in FIG. 29 and in FIG. 30,

FIG. 29 represents the nozzle with circular air inlet channels, in section in the plane A-A as marked in FIG. 28,

FIG. 30 represents in section in the plane A-A another form of the nozzle from FIG. 28, with conical air inlet channels,

FIG. 31 represents the nozzle from FIG. 28 in bottom view,

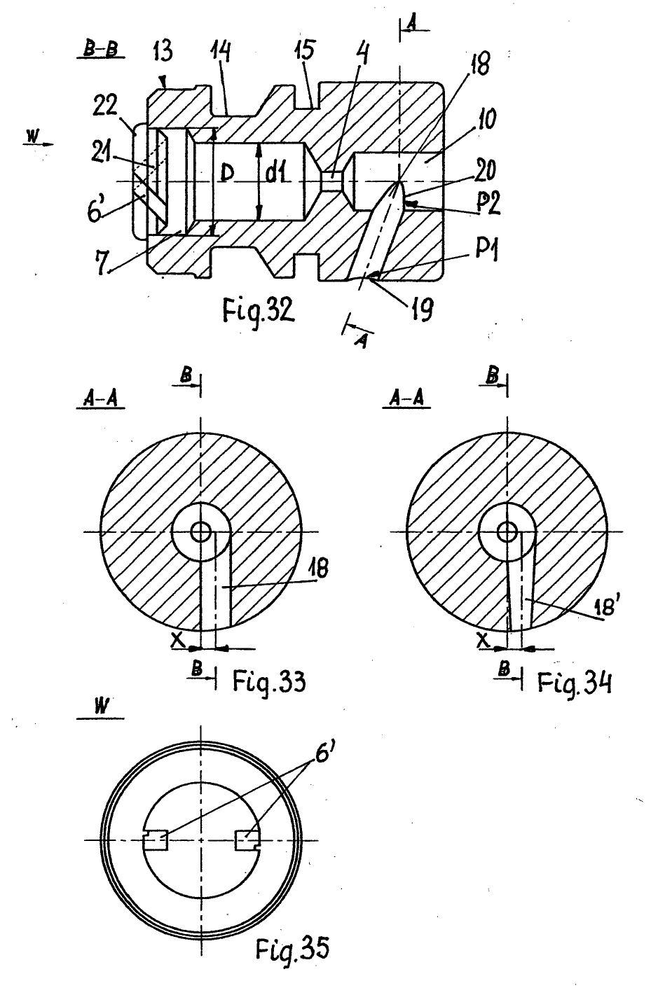

FIG. 32 represents a variant of the nozzle in longitudinal section in the plane B-B as marked in FIG. 33 and in FIG. 34,

FIG. 33 represents the nozzle with one circular air inlet channel in section in the plane A-A as marked in FIG. 32,

FIG. 34 represents in section in the plane A-A another form of the nozzle from FIG. 32, with one conical air inlet channel,

FIG. 35 represents the nozzle from FIG. 32 in bottom view,

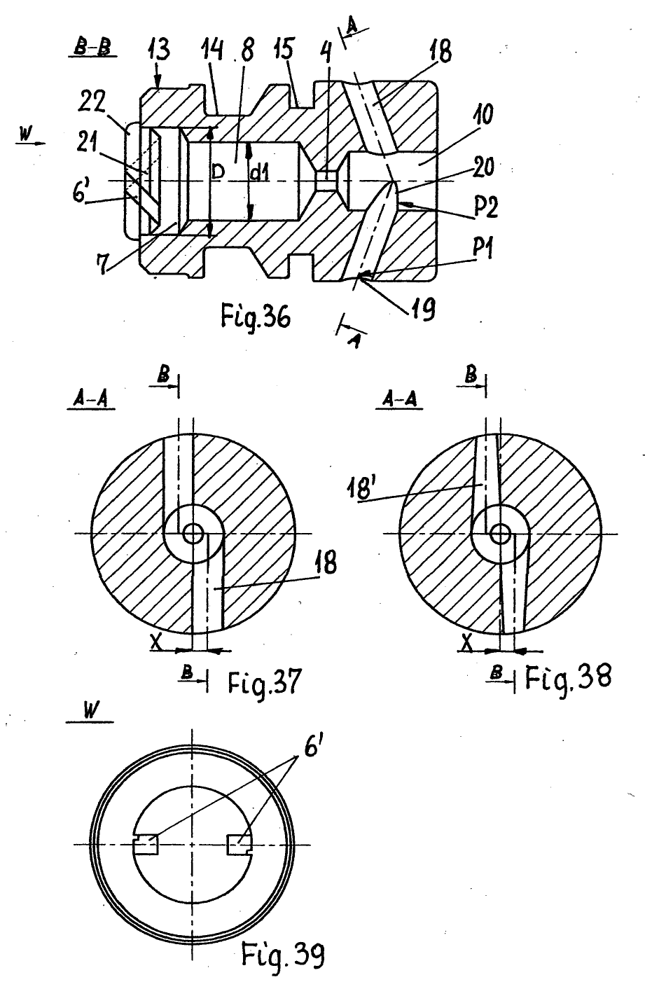

FIG. 36 represents a constructional variant of the nozzle in longitudinal section in the plane B-B as marked in FIG. 37 and in FIG. 38,

FIG. 37 represents the nozzle with one circular air inlet channel in section in the plane A-A as marked in FIG. 36,

FIG. 38 represents in section in the plane A-A another form of the nozzle from FIG. 36, with one conical air inlet channel,

FIG. 39 represents the nozzle from FIG. 36 in bottom section,

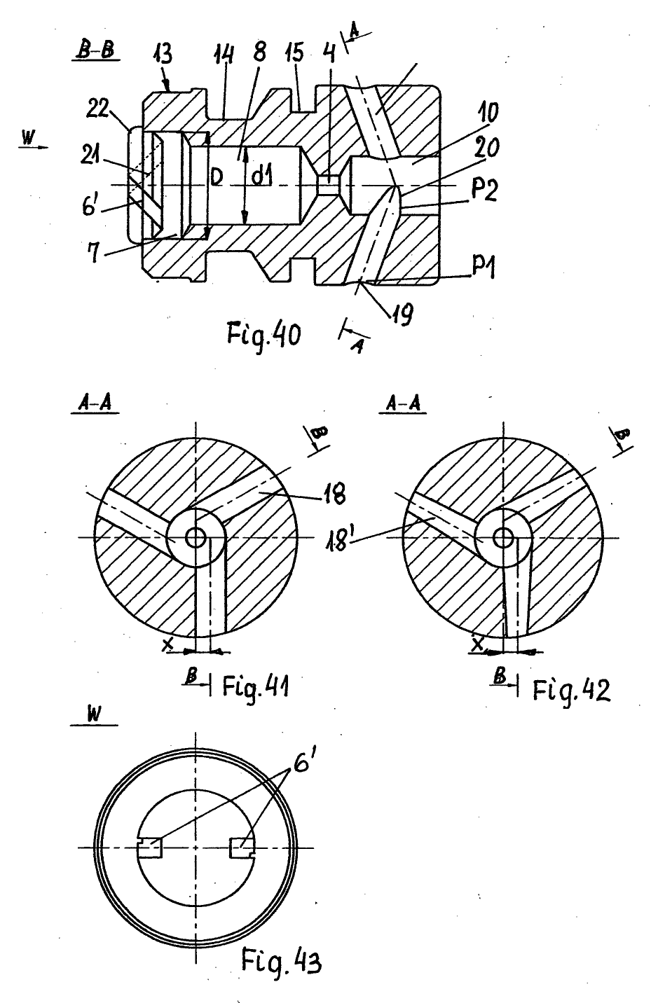

FIG. 40 represents a constructional variant of the nozzle in longitudinal section in the plane B-B as marked in FIG. 41 and in FIG. 42,

FIG. 41 represents the nozzle with circular air inlet channels, in section in the plane A-A as marked in FIG. 40,

FIG. 42 represents in section in the plane A-A another form of the nozzle from FIG. 40, with conical air inlet channels,

FIG. 43 represents the nozzle from FIG. 40 in bottom section.

### EXAMPLE I

The nozzle according to the invention contains a body 1 in the shape of a roll terminated in a threaded end-piece 2 at the base, in the upper part terminated in a head 3 having the shape of a regular hexagon or another shape corresponding to the function of angular rotation outside. The body 1 has a cylindrical through hole inside, situated in its longitudinal axis, consisting of sections which have different diameters and are separated by bevel phases. These cylindrical sections constitute chambers with different cross-sections, through which the water is supplied to the outlet opening 4 of the nozzle. In the inlet opening of the nozzle, from the water conduit, it is pushed-on the spin insert 5 with oblique through channels supplying water into the space over the insert, below called spin channels 6. The height of the spin insert 5 is less than the height of the inlet opening so that over the insert there is a free cylindrical space with the diameter D, constituting a spin chamber 7. The spin insert 5 has the shape of a roll in which there are two spin through channels 6. The spin channels are situated obliquely in the axial plane, at an acute angle relative to the longitudinal axis of the insert, and are positioned oppositely each other on both the sides of the axis. The outlets of these channels are near by the insert edge so that water under pressure is supplied towards the wall of the spin chamber 7 and is put in spinning in this chamber, forming a yet in the shape of an cone being hollow inside. Over the spin chamber 7 it is situated the first swirl chamber 8 the diameter d1 of which is less than the diameter D of the spin chamber 7. Over the first swirl chamber 8 there is the second swirl chamber 9 the diameter d2 of which is less than the diameter d1 of the first swirl chamber 8. Over the second swirl chamber 9 there is the outlet opening 4 of the nozzle, the diameter of which is the least. The outlet of the outlet opening 4 is at the bottom of the outlet chamber 10 located inside the head 3, and this chamber is coaxial with the outlet opening 4. In the inlet of the nozzle, below the spin insert 5, it is installed a gauze filter 11.

The nozzle is supplied from the bottom, water is fed through the spin channels 6 of the spin insert 5 into the spin chamber 7. The spin insert has no other through holes, therefore water is led to the chamber walls with high energy, causing strong spinning of it. From the spin chamber 7 water flows in rotational motion to the first swirl chamber 8, where it is set further in spinning with the result that its rotational velocity and pressure increase. In the next, second swirl chamber, with a smaller diameter, the rotational velocity and also the pressure of water stream increase further. The increase in rotational velocity and the difference of the cross-sections of the chambers are large enough to cause throttling the water flow in the first swirl chamber, and next in the second swirl chamber. Water ejecting from the outlet opening of the nozzle has very high kinetic energy enabling the water to be broken up in very little drops under maintaining the high kinetic energy of water particles. At the same time it turned out that the discharge of water from the nozzle is less than it could be expected on the ground of the well-known nozzle with comparable pressure parameters in water conduit as well as a comparable diameter of the outlet opening. It turned out that the discharge of water does not increase at the diameter of outlet opening of 1 mm, but it is the same as the discharge of the nozzle of 0.6 mm in diameter, at the same parameters of the water fed in the nozzle. The increase in diameter of the outlet opening up to 1 mm (by about 66%) has no influence on the amount of water discharge, which is the same as in case of the nozzle of 0.6 in diameter, at the diameter of 1.2 mm the discharge of water is the same as at the diameter of 0.8 mm and the like.

### EXAMPLE II

A solution analogous to that described in Example I, but the spin insert has an axial channel in the form of a cylindrical through hole, not shown in the drawing. The cross-sections of the spin channels as well as the axial channel are chosen so that 95% of the stream taken from the supply conduit and fed into the spin chamber flow through the spin channels.

### EXAMPLE III

As it is shown in FIG. 3 and FIG. 4, the solution is analogous to that described in Example I, but the spin insert 12 has the form of a solid of revolution shaped like a mushroom the head of which is in the upper part of the water inlet opening bevelled at its end. The head bottom adheres tight with its surface to the bevel surface, while the cylindrical stem is pushed-on in the spin chamber 7 whose diameter D is less than the diameter of the inlet opening. The spin insert 12 is provided with two spin through channels 6 arranged obliquely in the axial plane, at an acute angle relative to the longitudinal axis of the insert and positioned oppositely each other on both sides of the axis. The outlets of these channels are near by the insert edge. The nozzle has one swirl chamber—the first swirl chamber 8 with the diameter d1, connected with the spin chamber 7 and with the outlet opening 4.

### EXAMPLE IV

As shown in FIG. 5 and FIG. 6, the nozzle has a body 13 shaped like a roll, on the external surface of which at the bottom there is a trapezoidal circumferential groove 14 shaped like an asymmetrical trapezoid, suitably adapted to the shape of a typical hydraulic connection or spray unit socket, while a rectangular circumferential groove 15 for an assembly jig is situated above it. The body 13 has a cylindrical through hole inside, which is situated in the longitudinal axis, consisting of sections which have different diameters and constitute chambers. In the inlet opening of the nozzle it is pushed-on the spin insert 16 provided with the spin through channels 6 which feed water to the space over the insert and set it in rotational motion. The spin insert 16 is terminated in a flange 17 closing from the bottom the inlet opening of the nozzle. Over the insert there is a free cylindrical space D in diameter, constituting the spin chamber 7. The spin channels are arranged obliquely in the axial plane, at an acute angle relative to the longitudinal axis of the insert and are positioned oppositely each other on both sides of the axis. The outlets of these channels are near by the insert edge. The spin channels 6 have the form of cylindrical openings. Above the spin chamber 7 it is situated the first swirl chamber 8 the diameter d1 of which is less than the diameter D of the spin chamber 7. Over the first swirl chamber 8 there is the second swirl chamber 9 the diameter d2 of which is less than the diameter d1 of the first swirl chamber 8. Over the second swirl chamber 9 it is situated the outlet opening 4 of the nozzle, the diameter of which is the least.

### EXAMPLE V

As shown in FIG. 7 and FIG. 8, a solution analogous to that represented in Example I, but the outlet chamber 10 has three through holes in its walls, which connect the chamber with the atmosphere, constituting air inlet channels 18. The inlet channels 18 are evenly distributed on the circumference, and their axes are displaced by a certain distance X, in one direction, relative to the axial plane of the chamber. The inlet openings 19 of these channels 18 are outside the wall of the outlet chamber 10, while their outlet openings 20 are inside the chamber 10. The outlet openings 20 are situated above the outlet opening 4, at a certain distance from the face of the outlet chamber 10, so that the chamber's cylindrical part directing the yet of atomized water/air mixture towards the chamber outlet is situated above them. The inlet channels 18 are circular in cross-section and have equal or different diameters, less than the diameter of the outlet chamber 10. At an optimal constructional variant the side surfaces of the inlet channels 18 are one side internally tangent to the chamber 10, causing that the air is set in swirling more effectively. The axes of the channels 18 are inclined relative to the axial plane of the chamber 10 and converge towards the chamber outlet, but as well as they can lie in the plane normal to the chamber axis. The axes of the channels 18 intersect the axial plane on one or different level(s) and also may converge at one point. The inlet channels 18 are made so that the surface areas P2 of the outlet openings 20 are greater than the areas P1 of the inlet channels 19. It is especially advantageous when the ratio of the area P2 to the area P1 exceeds 1.16. The ratios of these surface areas for individual inlet channels may be the same or different.

The nozzle is supplied form the bottom, water under pressure is fed through the spin channels 6 of the spin insert 5 into the spin chamber 7. The spin insert has no other through holes, therefore water is led with high energy to the chamber walls with the result that it is set in strong swirling. From the spin chamber 7 the water flows with rotational motion into the first swirl chamber 8 where the process of putting water in swirling is continued, which results in increasing of its rotational velocity and pressure. In the next chamber, the second swirl chamber 9, with a smaller diameter, the rotational velocity of the stream and also the pressure still increase. From the outlet opening 4 a jet consisting of very small water drops ejects, filling in the outlet chamber 10 with sprayed fluid at the height of the upper edges of the outlet openings of the air channels, and moves in the cylindrical part towards the chamber outlet. The jet of very small water drops draws the air flowing through the air channels 18 to the outlet chamber 10 so that a more uniform water/air spray jet develops, which is led through the cylindrical end section of the outlet chamber 10 to the outside, to a dust source and to the places of possible ignition hazard by a spark. A greater uniformity of the jet enables the water consumption to be reduced generally without any change of cooling efficiency because an air addition to the air/water spray jet cools with the same or similar, and even greater quenching power of sparks. As a result of injection this action causes that a pressure below atmospheric develops in the chamber, at the height of the outlet openings of the channels, drawing in air through the inlet openings from outside of the chamber. The value of the pressure below atmospheric is the more, the more it is the surface area or the sum of the surface areas of the outlet openings 20 of the air inlet channels 18 situated in the chamber, which affects very advantageously the drop microstructure of the jet. Having a defined pressure below atmospheric and the difference of the surface areas of the air outlet openings arranged in the chamber and that of the air inlet openings situated outside the chamber, one obtains an increase of the energy of motion of the air being drawn in. It is obtained a very uniform mixture of air and liquid in the form of very small drops which have an adequately great kinetic energy. Such a mixture is highly effective in removing dust from the air and in limiting methane explosion hazards in the processes of mining. At the same time it turned out that the discharge of water from this nozzle is less than it should be expected from the well-known nozzle with comparable parameters of pressure in water conduit and comparable outlet opening diameter. It turned out that at the outlet opening diameter of 1 mm the discharge of water does not increase, is the same as the discharge of the nozzle 0.6 mm in diameter, at the same parameters of water being fed to the nozzle. The increase of the outlet opening diameter up to 1 mm (by about 66%) has no influence on the amount of water discharge, which is the same as in case of the nozzle 0.6 in diameter, at the diameter of 1.2 mm the discharge of water is the same as at the diameter of 0.8 mm, and the like.

### EXAMPLE VI

A solution analogous to that described in Example V, but the inlet channels 18′ have the shape of a circular truncated cone or conical ellipsoid the greater base of which is situated in the chamber 10, as represented in FIG. 9.

### EXAMPLE VII

As shown in FIG. 10 and FIG. 11, the solution is analogous to that represented in Example III, but the outlet chamber 10 has three through holes in its walls, which connect it with the atmosphere, constituting the air inlet channels 18. The inlet channels 18 are evenly distributed on the circumference, and their axes are displaced by a certain distance X in one direction relative to the axial plane of the chamber. The inlet openings 19 of these channels are outside of the wall of the outlet channel 10, while the outlet openings 20 are arranged inside the chamber 10. The outlet openings 20 are situated over the outlet opening 4, at a certain distance from the chamber face, so that the chamber's cylindrical part directing the yet of atomized water/air mixture towards the chamber outlet is situated above them. The inlet channels 18 are circular in cross-section and have equal or different diameters, less than the diameter of the outlet chamber 10. At an optimal constructional variant the side surfaces of these channels are one side internally tangent to the chamber 2, causing that the air is set in swirling more effectively. The axes of the channels 18 are inclined relative to the axial plane of the chamber 10 and converge towards the chamber outlet, but they also may lie in the plane normal to the chamber axis. The axes of the channels 18 intersect the axial plane on one or different level(s) and also may converge at one point. The inlet channels 18 are made so that the surface areas P2 of the outlet openings 20 are greater than the areas P1 of the inlet channels 19. It is especially advantageous when the ratio of the area P2 to the area P1 exceeds 1.16. The ratios of these surface areas for individual inlet channels may be the same or different.

### EXAMPLE VIII

A solution analogous to that described in Example VII, but the inlet channels 18′ have the shape of a circular truncated cone or conical ellipsoid the greater base of which is situated in the chamber 10, as represented in FIG. 12.

### EXAMPLE IX

As shown in FIG. 13 and FIG. 14, the nozzle is analogous to that represented in Example V, but the nozzle has only one, the first swirl chamber 8, connected with the spin chamber 7. The swirl chamber 8 is cylindrical in shape and connected with the outlet opening 4, and its diameter d1 is less than the diameter D of the spin chamber 7. The inlet channels 18 are circular in cross-section.

### EXAMPLE X

A solution analogous to that described in Example IX, but the inlet channels 18′ have the shape of a circular truncated cone or conical ellipsoid the greater base of which is situated in the chamber 10, as represented in FIG. 15.

### EXAMPLE XI

As shown in FIG. 16 and FIG. 17, the nozzle has a body 13 shaped like a roll, on the external surface of which at the bottom there is a trapezoidal circumferential groove 14 shaped like an asymmetrical trapezoid, suitably adapted to the shape of a typical hydraulic connection or spray unit socket, while a rectangular circumferential groove 15 for an assembly jig is situated above it. The body 13 has a cylindrical through hole inside, which is situated in the longitudinal axis, consisting of sections which have different diameters and constitute chambers.

Between the inlet opening arranged from the side of water conduit and the outlet opening 4 there is the spin chamber 7, which is situated over the spin insert 16 and connected with the first swirl chamber 8, which is connected further with the outlet opening 4. The outlet of the outlet opening 4 is at the bottom of the outlet chamber 10 located in the upper part of the body. In the inlet opening of the nozzle it is pushed-on the spin insert 16 provided with the spin through channels 6 which feed water to the spin chamber 7. The spin insert 16 is terminated in a flange 17 closing from the bottom the inlet opening of the nozzle. The spin channels 6 in the shape of cylindrical holes are situated obliquely in the axial plane, at an acute angle relative to the longitudinal axis of the insert and are positioned oppositely each other on both sides of the axis. The outlets of these channels are near by the insert edge so that water under pressure is led towards the wall of the spin chamber 7 and is set in swirling in this chamber, forming a stream in the shape of a hollow cone. The outlet chamber 10 has one through hole in its walls, which connects it with the atmosphere, constituting the air inlet channel 18. The axis of the inlet channels 18 is displaced by a certain distance X relative to the axial plane of the chamber. The inlet opening 19 of the channel is outside of the wall of the outlet channel 10, while the outlet opening 20 is arranged inside the chamber 10. The outlet opening 20 is situated over the outlet opening 4, at a certain distance from the chamber face so that the chamber's cylindrical part directing the yet of atomized water/air mixture towards the chamber outlet is situated above it. The inlet channel 18 is circular in cross-section and its diameter is less than the diameter of the chamber 10. At an optimal constructional variant the side surface of the channel 18 is one side internally tangent to the chamber 10, causing that the air is set in swirling more effectively. The axis of the inlet channel 18 is inclined relative to the axial plane of the chamber 10 and slops up towards the chamber outlet, but it also may lie in the plane normal to the chamber axis. The inlet channel 18 is made so that the surface area P2 of the outlet opening 20 is greater than the area P1 of the inlet opening 19. It is especially advantageous when the ratio of the area P2 to the area P1 exceeds 1.16.

### EXAMPLE XII

A solution analogous to that described in Example XI, but the inlet channels 18′ have the shape of a circular truncated cone or conical ellipsoid the greater base of which is situated in the chamber 10, as represented in FIG. 18.

### EXAMPLE XIII

As shown in FIG. 20 and FIG. 21, the solution is analogous to that described in Example XI, but in the wall of the outlet chamber 10 there are two air inlet channels 18. Their inlet openings 19 are on the outside of the chamber, while their outlet openings 20 are arranged in the chamber. The outlet openings 20 of the air inlet channels are situated over the outlet opening 4, at a certain distance from the face of the chamber 10, so that the chamber's cylindrical part directing the yet of atomized water/air mixture towards the chamber outlet is situated above them. The inlet channels 18 are circular in cross-section and have equal or different diameters, less than the diameter of the chamber 10. The inlet channels 18 are positioned oppositely each other on both sides of the chamber 10. The axes of these channels are situated at the same distance from the axial plane of the chamber, the axis of one channel is positioned on one side of this plane, while the axis of the other channel on the other side. The side surface of the channel 18 may be one side internally tangent to the chamber 10, causing that the air is set in swirling more effectively. The axes of the inlet channels 18 are inclined relative to the axial plane of the chamber 10 and converge towards the chamber outlet. The axes of these channels intersect the axial plane of the nozzle on the same or different level(s), and they also may converge at one point. The inlet channels 18 are made so that the surface areas P2 of the outlet openings 20 are greater than the areas P1 of the inlet openings 19. It is especially advantageous when the ratio of the area P2 to the area P1 exceeds 1.16. The ratios of these surface areas for the individual inlet channels may be the same or different.

### EXAMPLE XIV

A solution analogous to that described in Example XIII, but the inlet channels 18′ have the shape of a circular truncated cone or conical ellipsoid the greater base of which is situated in the chamber 10, as represented in FIG. 22.

### EXAMPLE XV

As shown in FIGS. 24-27, a solution analogous to that represented in Example XI, but in the wall of the outlet chamber 10 there are three air inlet channels 18, evenly distributed on its circumference. The axes of these channels are situated at a certain distance X from the axial plane of the chamber.

### EXAMPLE XVI

A solution analogous to that described in Example XV, but the inlet channels 18′ have the shape of a circular truncated cone or conical ellipsoid the greater base of which is situated in the chamber 10, as represented in FIG. 26.

### EXAMPLE XVII

As shown in FIGS. 28-31, a solution analogous to that represented in Example XV, but between the spin chamber 7 and the outlet opening 4 there are two swirl chambers, the first swirl chamber 8 whose diameter d1 is less than the diameter D of the spin chamber 7, and the second swirl chamber 9 whose diameter d2 is less than the diameter d1 of the first swirl chamber 8.

### EXAMPLE XVIII

A solution analogous to that described in Example XVII, but the inlet channels 18′ have the shape of a circular truncated cone or conical ellipsoid the greater base of which is situated in the chamber 10, as represented in FIG. 30.

### EXAMPLE XIX

As shown in FIGS. 32-35, a solution analogous to that represented in Example XI, but the spin insert 21 has the shape of a roll provided with the flange 22 and the spin channels 6′ in the shape of rectangular grooves with equal cross-sections, arranged along the screw line on the insert circumference. The outlets of the spin channels 6′ are in the spin chamber 7 and are positioned oppositely each other on both sides of its longitudinal axis.

### EXAMPLE XX

A solution analogous to that described in Example XIX, but the inlet channels 18′ have the shape of a circular truncated cone or conical ellipsoid the greater base of which is situated in the chamber 10, as represented in FIG. 34.

### EXAMPLE XXI

As shown in FIGS. 36-37, a solution analogous to that represented in Example XIII, but the spin insert 21 has the shape of a roll provided with the flange 22 and the spin channels 6′ in the shape of rectangular grooves with equal cross-sections, arranged along the screw line on the insert circumference. The outlets of the spin channels 6′ are in the spin chamber 7 and are positioned oppositely each other on both sides of its longitudinal axis.

### EXAMPLE XXII

A solution analogous to that described in Example XXI, but the inlet channels 18′ have the shape of a circular truncated cone or conical ellipsoid the greater base of which is situated in the chamber 10, as represented in FIG. 38.

### EXAMPLE XXIII

As shown in FIGS. 40-43, a solution analogous to that represented in Example XV, but the spin insert 21 has the shape of a roll provided with the flange 22 and two spin channels 6′ in the shape of rectangular grooves with equal cross-sections, arranged along the screw line on the insert circumference. The outlets of the spin channels 6′ are situated in the spin chamber 7, on the opposite sides of its longitudinal axis.

### EXAMPLE XXIV

A solution analogous to that described in Example XXIII, but the inlet channels 18′ have the shape of a circular truncated cone or conical ellipsoid the greater base of which is situated in the chamber 10, as represented in FIG. 42.

### EXAMPLE XXV

The nozzle, not shown in the drawing, has a body in the shape of a roll the outer side of which is formed so that the nozzle can be mounted in a sprayer, for example screwed in, or in a typical hydraulic connection, as explained above in the examples of realization of the invention. The body has inside a cylindrical through hole situated in its longitudinal axis, consisting of sections which have different diameters and constitute chambers. On the side opposite to the outlet opening of the nozzle it is the section of the cylindrical hole with the greatest diameter, which constitutes the spin chamber. The spin chamber is connected with the water supply through two spin channels situated in the body, transversely to its longitudinal axis, tangent to the chamber, oppositely each other. Between the spin chamber and the outlet opening there is/are one or more cylindrical swirl chamber(s), and each following out of them has the diameter less than the diameter of the preceding swirl chamber. The diameter of the first swirl chamber, connected with the spin chamber, is less than that of the spin chamber. The cylindrical hole in the body is closed with a plug. In this nozzle the whole stream drawn from the water conduit flows through the spin channels and is subject to further swirling and also to throttling in the swirl chambers, in consequence achieving energy and the degree of atomization/the size of drops/adequate for effective dust control. The nozzle may have a body with the outlet chamber situated over the outlet opening. The walls of the outlet chamber may have air inlet channels, similar as above described, in other examples of realization of the invention.

### EXAMPLE XXVI

The water drawn from the water supply conduit is fed whole or at 95% to the nozzle through the spin channels 6,6′ situated at angle relative to the longitudinal axis of the cylindrical hole, causing that the water is set in swirling in the spin chamber. Next the stream is led through one or more successive cylindrical swirl chamber(s) 8,9, and the diameter d2 of each following chamber 9 out of them is less than the diameter d1 of the preceding chamber 8. The diameter d1 of the first swirl chamber 8 is less than the diameter D of the spin chamber 7. From the last swirl chamber the stream is led to the outlet opening 4. Then the stream flowing from the outlet opening 4 is led through an injector device in the form of the outlet chamber 10 provided with through holes, contained in the body 1, 13 of the nozzle, or in another external unit, for example in the pick holder for a shearer drum or a cutting head of a winning machine in mines. The outlet chamber 10 in the body 1,13 of the nozzle has in its walls one or more through hole(s) constituting the air inlet channels 18,18′. In order to achieve a better effect of water atomization/corresponding to the smaller size of drops/one uses air inlet channels 18,18′, the external inlet openings 19 of which have the surface areas P1 less than the areas P2 of the outlet openings 20 situated inside the outlet chamber 10. The ratio of the area P2 of the outlet opening 20 to the area P1 of the inlet opening 19 is equal to or greater than 1.16.

1-52. (canceled)

53. The water spray nozzle, containing a body, advantageously in the shape of a solid of revolution, with a cylindrical through hole running along its axis, provided with elements setting water stream in swirling, which contain spin channels connected with a spin chamber coaxial with the cylindrical hole characterized in that between the spin chamber (7) and the outlet opening (4) the cylindrical hole in the body (1) contains at least one swirl chamber (8) cylindrical in shape, and the diameter (d1) of the first swirl chamber (8), connected with the spin chamber (7), is less than the diameter (D) of the spin chamber (7), and when the number of swirl chambers is greater than one, the diameter (d2) of each following swirl chamber (9) is less than the diameter (d1) of the preceding chamber (8).

54. The nozzle as claimed in claim 53 characterized in that it has two swirl chambers, the first swirl chamber (8) connected with the spin chamber (7) and the second swirl chamber (9) connected with the first swirl chamber (8).

55. The nozzle as claimed in claim 53 characterized in that the spin chamber (7) is connected with water supply through the spin channels (6) situated directly in the body (1) of the nozzle, tangent to the chamber and oppositely each other, and the through hole in the body (1) is closed from the bottom.

56. The nozzle as claimed in claim 53 characterized in that it has the spin insert (5,12,16) in the shape of a roll, which has advantageously body, situated at an acute angle relative to its longitudinal axis, oppositely each other on both sides of the axis, and the outlets of these channels are arranged near by the insert edge.

57. The nozzle as claimed in claim 53 characterized in that the body (1) has an outlet chamber (10) situated over the outlet opening (4), and the outlet chamber (10) has one or more air inlet channel(s) (18, 18′) the inlet openings of which (19) are on the outside, while the outlet openings (20) are arranged inside the chamber.

58. The nozzle as claimed in claim 53 characterized in that the body (1) has an outlet chamber (10) situated over the outlet opening (4), and the outlet chamber (10) has one or more air inlet channel(s) (18, 18′) the inlet openings of which (19) are on the outside, while the outlet openings (20) are arranged inside the chamber, and the air inlet channels (18) are circular in cross-section.

59. The nozzle as claimed in claim 53 characterized in that the body (1) has an outlet chamber (10) situated over the outlet opening (4), and the outlet chamber (10) has one or more air inlet channel(s) (18, 18′) the inlet openings of which (19) are on the outside, while the outlet openings (20) are arranged inside the chamber, and the air inlet channels (18′) have the shape of a circular truncated cone or conical ellipsoid the greater base of which is situated in the outlet chamber (10).

60. The nozzle as claimed in claim 53 characterized in that the body (1) has an outlet chamber (10) situated over the outlet opening (4), and the outlet chamber (10) has one or more air inlet channel(s) (18, 18′) the inlet openings of which (19) are on the outside, while the outlet openings (20) are arranged inside the chamber, and the air inlet channels (18,18′) are made so that the surface areas (P2) of their outlet openings (20) are greater than the areas (P1) of their inlet openings (19).

61. The nozzle as claimed in claim 53 characterized in that the body (1) has an outlet chamber (10) situated over the outlet opening (4), and the outlet chamber (10) has one or more air inlet channel(s) (18, 18′) the inlet openings of which (19) are on the outside, while the outlet openings (20) are arranged inside the chamber, and the ratio of the area (P2) of the outlet opening (20) to the area (P1) of the inlet opening (19) exceeds 1.16.

62. The nozzle as claimed in claim 53 characterized in that the body (1) has an outlet chamber (10) situated over the outlet opening (4), and the outlet chamber (10) has one or more air inlet channel(s) (18, 18′) the inlet openings of which (19) are on the outside, while the outlet openings (20) are arranged inside the chamber, and the axes of the air inlet channels (18, 18′) are situated at a certain distance (X) from the axial plane of the outlet chamber (10).

63. The nozzle as claimed in claim 53 characterized in that the body (1) has an outlet chamber (10) situated over the outlet opening (4), and the outlet chamber (10) has one or more air inlet channel(s) (18, 18′) the inlet openings of which (19) are on the outside, while the outlet openings (20) are arranged inside the chamber, and the axes of the air inlet channels (18, 18′) are situated at a certain distance (X) from the axial plane of the outlet chamber (10), and the side sides of the inlet channels (18, 18′) are one side tangent to the wall of the outlet chamber (10).

64. The nozzle as claimed in claim 53 characterized in that the body (1) has the shape of a roll the lower end-piece of which has an external thread, and its upper end-piece in the form of a head (3) has externally the shape corresponding to the function of angular rotation, advantageously of a hexagon, and the outlet chamber (10) is inside the head (3).

65. The nozzle as claimed in claim 53 characterized in that the body (1) has an outlet chamber (10) situated over the outlet opening (4), and the outlet chamber (10) has one or more air inlet channel(s) (18, 18′) the inlet openings of which (19) are on the outside, while the outlet openings (20) are arranged inside the chamber, and the body (1) has the shape of a roll the lower end-piece of which has an external thread, and its upper end-piece in the form of a head (3) has externally the shape corresponding to the function of angular rotation, advantageously of a hexagon, and the outlet chamber (10) is inside the head (3).

66. The water spray nozzle containing a body, advantageously in the shape of a solid of revolution, with a cylindrical through hole running along its axis, which contains elements shaping the stream into a cone and an outlet chamber situated over the outlet opening of the nozzle characterized in that the outlet chamber (10) has one or more air inlet channel(s) (18, 18′) the inlet openings (19) of which are on its outer side, while the outlet openings (20) are arranged inside the chamber.

67. The nozzle as claimed in claim 66 characterized in that the air inlet channels (18) are circular in cross-section.

68. The nozzle as claimed in claim 66 characterized in that the air inlet channels (18′) have the shape of a circular truncated cone or conical ellipsoid the greater base of which is situated in the outlet chamber (10).

69. The nozzle as claimed in claim 66 characterized in that the air inlet channels (18) are made so that the surface areas (P2) of their outlet openings (20) are greater than the areas (P1) of their inlet openings (19).

70. The nozzle as claimed in claim 66 characterized in that the air inlet channels (18) are made so that the surface areas (P2) of their outlet openings (20) are greater than the areas (P1) of their inlet openings (19), and the ratio of the area (P2) of the outlet opening (20) to the area (P1) of the inlet opening (19) is equal to or greater than 1.16.

71. The nozzle as claimed in claim 66 characterized in that the axes of the air inlet channels (18, 18′) are situated at a certain distance (X) from the axial plane of the outlet chamber (10).

72. The nozzle as claimed in claim 66 characterized in that the axes of the air inlet channels (18, 18′) are situated at a certain distance (X) from the axial plane of the outlet chamber (10), and the side surfaces of the air inlet channels (18, 18′) are one side internally tangent to the wall of the outlet chamber (10).

73. The nozzle as claimed in claim 66 characterized in that it has a spin insert (5,12,16,21) in the shape of a roll provided with spin channels (6,6′), which is seated in the cylindrical body (1) from the water conduit, and the axes of these channels are positioned at an acute angle relative to its longitudinal axis so that the channel outlets are arranged in the spin chamber (7), which is coaxial with the cylindrical hole of the nozzle, near by the wall of the chamber.

74. The nozzle as claimed in claim 66 characterized in that it has a spin insert (5,12,16,21) in the shape of a roll provided with spin channels (6,6′), which is seated in the cylindrical body (1) from the water conduit, and the axes of these channels are positioned at an acute angle relative to its longitudinal axis so that the channel outlets are arranged in the spin chamber (7), which is coaxial with the cylindrical hole of the nozzle, near by the wall of the chamber, and nozzle has at least two spin channels situated directly in the nozzle body, transversely to the longitudinal axis of the cylindrical through hole and tangent to the spin chamber as well as oppositely each other, and the outlets of these channels are inside the spin chamber, and the cylindrical through hole in the body is closed from the bottom.

75. The nozzle as claimed in claim 66 characterized in that it has a spin insert (5,12,16,21) in the shape of a roll provided with spin channels (6,6′), which is seated in the cylindrical body (1) from the water conduit, and the axes of these channels are positioned at an acute angle relative to its longitudinal axis so that the channel outlets are arranged in the spin chamber (7), which is coaxial with the cylindrical hole of the nozzle, near by the wall of the chamber, and between the spin chamber (7) and the outlet opening (4) there is (are) one or more cylindrical swirl chamber(s) (8, 9), and the diameter of each following chamber out of them is less than the diameter of the preceding swirl chamber (d2<d1), and the first swirl chamber (8) has the diameter (d1) less than diameter (D) of the spin chamber (7), respectively.

76. The nozzle as claimed in claim 66 characterized in that it has a spin insert (5,12,16,21) in the shape of a roll provided with spin channels (6,6′), which is seated in the cylindrical body (1) from the water conduit, and the axes of these channels are positioned at an acute angle relative to its longitudinal axis so that the channel outlets are arranged in the spin chamber (7), which is coaxial with the cylindrical hole of the nozzle, near by the wall of the chamber, and nozzle has at least two spin channels situated directly in the nozzle body, transversely to the longitudinal axis of the cylindrical through hole and tangent to the spin chamber as well as oppositely each other, and the outlets of these channels are inside the spin chamber, and the cylindrical through hole in the body is closed from the bottom, and between the spin chamber (7) and the outlet opening (4) there is (are) one or more cylindrical swirl chamber(s) (8, 9), and the diameter of each following chamber out of them is less than the diameter of the preceding swirl chamber (d2<d1), and the first swirl chamber (8) has the diameter (d1) less than diameter (D) of the spin chamber (7), respectively.

77. The nozzle as claimed in claim 66 characterized in that it has a spin insert (5,12,16,21) in the shape of a roll provided with spin channels (6,6′), which is seated in the cylindrical body (1) from the water conduit, and the axes of these channels are positioned at an acute angle relative to its longitudinal axis so that the channel outlets are arranged in the spin chamber (7), which is coaxial with the cylindrical hole of the nozzle, near by the wall of the chamber, and between the spin chamber (7) and the outlet opening (4) there is (are) one or more cylindrical swirl chamber(s) (8, 9), and the diameter of each following chamber out of them is less than the diameter of the preceding swirl chamber (d2<d1), and the first swirl chamber (8) has the diameter (d1) less than diameter (D) of the spin chamber (7), respectively, and nozzle has two swirl chambers (8,9), the first swirl chamber (8) connected with the spin chamber (7), and the second swirl chamber (9) connected with the first swirl chamber (8) and the outlet opening (4).

78. The nozzle as claimed in claim 66 characterized in that it has a spin insert (5,12,16,21) in the shape of a roll provided with spin channels (6,6′), which is seated in the cylindrical body (1) from the water conduit, and the axes of these channels are positioned at an acute angle relative to its longitudinal axis so that the channel outlets are arranged in the spin chamber (7), which is coaxial with the cylindrical hole of the nozzle, near by the wall of the chamber, and nozzle has at least two spin channels situated directly in the nozzle body, transversely to the longitudinal axis of the cylindrical through hole and tangent to the spin chamber as well as oppositely each other, and the outlets of these channels are inside the spin chamber, and the cylindrical through hole in the body is closed from the bottom, and between the spin chamber (7) and the outlet opening (4) there is (are) one or more cylindrical swirl chamber(s) (8, 9), and the diameter of each following chamber out of them is less than the diameter of the preceding swirl chamber (d2<d1), and the first swirl chamber (8) has the diameter (d1) less than diameter (D) of the spin chamber (7), respectively, and nozzle has two swirl chambers (8,9), the first swirl chamber (8) connected with the spin chamber (7), and the second swirl chamber (9) connected with the first swirl chamber (8) and the outlet opening (4).

79. The nozzle as claimed in claim 66 characterized in that the body (1) has the shape of a roll the lower end-piece of which has an external thread, while the upper part in the shape of a head (3) has externally the shape corresponding to the function of angular rotation, advantageously a hexagon, and inside the head (3) there is the outlet chamber (10) provided with the outlet opening (4) in the bottom.

80. The method of optimization of the working parameters of the water spray nozzle consisting in that the water fed to the nozzle is put in rotational motion in the cylindrical spin chamber characterized in that the stream from the water supply conduit is led to the spin chamber (7) whole or in the amount of at least 95% through the spin channels (6,6′) positioned at angle relative to its longitudinal axis, and then it is led through one or more successive cylindrical swirl chamber(s) (8,9) and next it is led to the outlet opening (4), and the diameter (d2) of each following chamber (9) is less than the diameter (d1) of the chamber (8) being before it, and the diameter (d1) of the first swirl chamber (8) is less than the diameter (D) of the spin chamber (7).

81. The method as claimed in claim 80 characterized in that the stream flowing from the outlet opening (4) is led through an injection device in the form of the outlet chamber (10) in the body (1,13) of the nozzle, or in another external device, and the chamber has in its walls one or more through hole(s) constituting air inlet channels (18,18′).

82. The method as claimed in claim 80 characterized in that one applies air inlet channels (18,18′) the external inlet openings (19) of which have the surface areas (P1) less than the areas (P2) of the outlet openings (20) situated inside the chamber (10).

83. The method as claimed in claim 80 characterized in that one applies air inlet channels (18,18′) the external inlet openings (19) of which have the surface areas (P1) less than the areas (P2) of the outlet openings (20) situated inside the chamber (10), and the ratio of the area (P2) of the outlet opening (20) to the area (P1) of the inlet opening (19) is equal to or greater than 1.16.
